(19) United States
(12) Patent Application Publication
(10) Pub. No.: US 2008/0194230 A1
(43) Pub. Date: Aug. 14, 2008

(54) Method for Charge Display for Sip Connections on Several Terminals

(75) Inventor: Renate Zygan, Munchen (DE)

Correspondence Address: BELL, BOYD & LLOYD, LLP, P.O. BOX 1135, CHICAGO, IL, 60690, US

(73) Assignee: Nokia Siemens Networks GmbH & Co KG, Munich (DE)

(21) Appl. No.: 11/911,488

(22) PCT Filed: Apr. 4, 2006
(86) PCT No.: PCT/EP06/61298

§ 371 Date: Oct. 17, 2007

(30) Foreign Application Priority Data
Apr. 12, 2005 (EP) 05007983.9

(51) Int. Cl. H04M 15/08

(52) U.S. Cl. 455/408

(57) ABSTRACT

The aim of the invention is the calculation in real time of applicable charges by a SIP application server during a SIP connection in a SIP-based voice network and transmission thereof to the A-side SIP user terminal and also to at least one further SIP user terminal. Said aim is achieved, whereby the provision of the determined connection charges is achieved by use of a connection-independent SIP signalling channel.

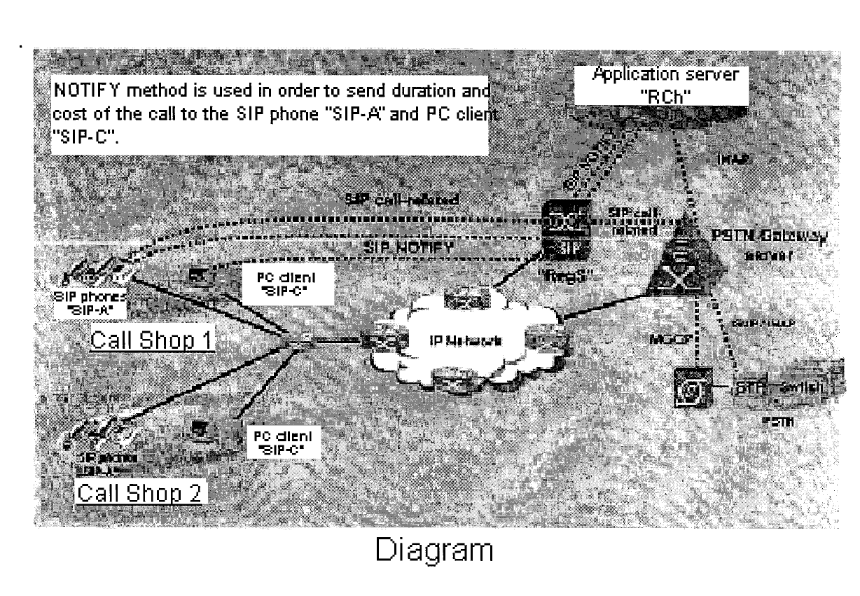

### CLAIM FOR PRIORITY

This application is a national stage application of PCT/EP2006/061298, filed Apr. 4, 2006, which claims the benefit of priority to EP05007983, filed Apr. 12, 2005, the contents of which are hereby incorporated by references.

### TECHNICAL FIELD OF THE INVENTION

The invention relates to a method and device for charge display for SIP connections.

### BACKGROUND OF THE INVENTION

A SIP-based voice network, according to the current prior art, consists mainly of a SIP registrar server “RegS”, at which the SIP user terminals register using their current IP addresses and which ensures that the IP address is transferred between two SIP users A and B, and other application servers which are included by the SIP registrar server “RegS” in the SIP signaling if additional application functions are required. In many cases, servers for the gateway to TDM telephone networks are also part of a SIP-based voice network.

In such a SIP-based voice network it should be possible for a SIP-application server “RCh”, during a SIP connection, to calculate the applicable charges in real time and to transmit said charges both to the A-side SIP user “SIP-A” and also to at least one other SIP user terminal “SIP-C”. One example of this application is privately operated call shops in which the current charges are to be displayed both to the calling party “SIP-A” and also to the operator of the call shop “SIP-C” in real time.

In order to support charge display during a SIP connection, procedures are currently being discussed and standardized that use connection-related SIP signaling analogously to the signaling of call charges during a TDM connection.

### SUMMARY OF THE INVENTION

In one embodiment of the invention, there is a method for charge display in SIP connections, according to which information required for charge calculation of a SIP connection by an application server is received via a call-control interface, the connection charges are determined by the application server with the help of the aforementioned information, and provision of the calculated connection charges via a connection-independent SIP signaling channel to at least one SIP terminal is carried out by the application server.

In one aspect of the invention, the charge information is packaged into a standardized SIP message by the application server for the purpose of provision.

In another aspect of the invention, provision of the aforementioned standardized SIP message to a SIP terminal via a registrar server of the SIP network is implemented by using the user registration function of the registrar server for this purpose.

In still another aspect of the invention, in order to protect the aforementioned standardized SIP message, the procedures introduced for the signaling relationship between a user of the SIP connection (SIP-A) and a registrar server are used for authentication of the SIP transmitter and/or for protection of the transferred data.

In another embodiment of the invention, the application server of a SIP network, which, in relation to a connection, receives the data required for charge calculation of the SIP connection via a call control interface, determines the charges of the SIP connection, and transfers the calculated charges to at least one SIP terminal via a signaling channel that is independent of the SIP connection.

### DETAILED DESCRIPTION OF THE INVENTION

In one embodiment of the invention, there is a method for the multi-item charge display for SIP connections. The application server “RCh” receives the connection data in its sample network configuration via an INAP interface from the PSTN gateway server. Alternatively, it would be possible for it to receive the connection data directly from the SIP call server, which is often at the same time the SIP registrar, via a second, connection-related SIP interface.

According to the method, a connection-independent SIP signaling channel is used instead of connection-related SIP signaling for transmission of call charges from the application server “RCh” to the SIP terminals “SIP-A” and

According to another embodiment of the invention, the charge information is packaged by the application server “RCh”, into an IETF-standardized SIP message (e.g. NOTIFY in accordance with RFC 3265) for the signaling of events. For this purpose, an event type that is specific for real-time charge display is defined, and also a corresponding data structure (event package) for the transmitted charge information. The application server “RCh” transmits NOTIFY messages to “SIP-A” and “SIP-C”. The content of the NOTIFY message to “SIP-A” and the content of the NOTIFY message to “SIP-C” are defined by the application server “RCh”. To enable a suitable display of data to appear at the terminals “SIP-A” and “SIP-C”, it is necessary for the content and the relevant data structure to be agreed with the manufacturer of the SIP user terminals.

The application server “RCh” receives, from the SIP-based voice network, via any call control interface (e.g. SIP from a SIP-call control server or—for example—INAP from the PSTN gateway), information about
“SIP-A” user identifier (e.g. E.164@RegS)
start time and date of the SIP connection
end time and date of the SIP connection
destination B of the SIP connection (e.g. E.164 number in the PSTN).

The application server “RCh” determines the call charges and also the further user “SIP-C” pertaining to the identification of the user “SIP-A” on the basis of administered data and generates the aforementioned standardized SIP message (NOTIFY in accordance with RFC 3265) to “SIP-A” and “SIP-C”.

According to still another embodiment of the invention, the user registration function of the SIP registrar server “RegS” is used for provision of the SIP messages NOTIFY to “SIP-A” and “SIP-C”. For this purpose, the application server transmits the SIP messages NOTIFY generated by it to the SIP registrar server “RegS” and the latter forwards it, on the basis of the IP addresses registered with it, to the SIP terminals “SIP-A” and “SIP-C”. The reception of NOTIFY messages is acknowledged in accordance with RFC 3265. A separate registration procedure for the NOTIFY messages of the application server “RCh” is not used (no “SUBSCRIBE” procedure. This is optional in accordance with RFC 3265.)

The procedures introduced for the signaling relationship between “SIP-A” and “RegS” for authenticating the SIP transmitter (SIP message authentication) and for protecting the transferred data (SIP message integrity), in particular the passwords or certificates used for this purpose, are reused for protection of the NOTIFY messages for charge display according to one embodiment of the invention.

The charge information received is displayed on the screen in the user terminals “SIP-A” and “SIP-C”.
The specified method is an end-to-end procedure with minimal demands on the SIP network. Generic functions (transfer of SIP connection data and—according to one embodiment of the invention—relay of SIP NOTIFY reports) are required of the SIP network, as they are also already made available for other applications. The application-specific expansions for charge display apply in the application server “RCh” and in the SIP user terminals. The method can therefore be introduced into existing SIP networks with minimal costs.
It is particularly flexible as an end-to-end method. If any amendments or expansions are required, the application server “RCh” and possibly the SIP user terminals involved are affected.
When SIP-connection-related signaling is used, the problem occurs wherein the charge information is to be transmitted to the terminal “SIP-C”, which—in most cases—is not actually involved in the SIP connection from “SIP-A” to the destination B. By using SIP connection-independent signaling both to “SIPA” and to “SIP-C”, this problem is avoided.
In contrast to the use of standardized SIP messaging systems (e.g. a presence-based instant messaging system) for the transmission of SIP connection charge data, separate registration of terminals is not required for this application. Instead, according to one embodiment of the invention, the registration of terminals is reused for the charged SIP connections.
   This increases the reliability of the overall solution.
   This increases the reusability of procedures for the authentication and protection of data integrity for SIP connection setup messages and for SIP NOTIFY messages for the charge display.

What is claimed is:

1. A method for charge display in SIP connections, comprising:
receiving information required for charge calculation of a SIP connection by an application server via a call-control interface;
determining the connection charges by the application server based on the information; and
c) performing a provision of the calculated connection charges via a connection-independent SIP signaling channel to at least one SIP terminal by the application server.

2. The method as claimed in claim 1,
wherein
the charge information is packaged into a standardized SIP message by the application server for the provision.

3. The method as claimed in claim 1,
wherein provision of the aforementioned standardized SIP message to a SIP terminal via a registrar server of the SIP network is implemented by using the user registration function of the registrar server.

4. The method as claimed in claims 1,
wherein, in order to protect the aforementioned standardized SIP message, the procedures introduced for the signaling relationship between a user of the SIP connection and a registrar server are used for authentication of the SIP transmitter and/or for protection of the transferred data.

5. An application server of a SIP network, comprising:
a call control interface receives the data required for charge calculation of the SIP connection in relation to a connection, wherein
the call control interface determines the charges of the SIP connection, and
transfers the calculated charges to at least one SIP terminal via a signaling channel that is independent of the SIP connection.
